(19) United States
(12) Patent Application Publication
(10) Pub. No.: US 2022/0112404 A1
(43) Pub. Date: Apr. 14, 2022

(54) THERMALLY BONDABLE ADHESIVE TAPE BACKING

(71) Applicant: 3M INNOVATIVE PROPERTIES COMPANY, St. Paul, MN (US)

(72) Inventor: Matthew J. Bongers, Minneapolis, MN (US)

(21) Appl. No.: 17/418,944

(22) PCT Filed: Dec. 27, 2019
(86) PCT No.: PCT/IB2019/061396

§ 371 Date: Jun. 28, 2021

Related U.S. Application Data
(60) Provisional application No. 62/877,504, filed on Jul. 23, 2019.
(60) Provisional application No. 62/786,619, filed on Dec. 31, 2018.

(51) Int. Cl. C09J 7/35; C09J 7/38; C09J 175/06; C09J 175/08

(52) U.S. Cl. CPC C09J 7/35; C09J 7/385; C09J 175/06; C09J 175/08; C09J 2301/1242; C09J 2301/302; C09J 2301/18; C09J 2400/26; C09J 2469/006; C09J 2455/006; C09J 2433/00; C09J 2483/00; C09J 2301/304

(57) ABSTRACT

The disclosed thermally bondable adhesive tape backing has a pressure-sensitive adhesive at a surface and a thermoplastic polyurethane adhesive at an opposite surface for thermal bonding to a device. The thermoplastic polyurethane adhesive softens and melts at a relatively low temperature. Therefore, melting of thermoplastic polyurethane adhesive is achieved while the pressure-sensitive adhesive remains in place and is not pressed away at the region of the thermal bonding.

### TECHNICAL FIELD

The present disclosure relates to a thermally bondable adhesive tape backing, a device thermally bonded to the thermally bondable adhesive tape backing, and a method of thermally bonding a device to a thermally bondable adhesive tape backing.

### BACKGROUND

Exposed pressure-sensitive adhesive surfaces work well to secure devices to various articles. For example, medical devices can use pressure-sensitive adhesive to secure the medical device to skin. To have strong attachment between the device and the pressure-sensitive adhesive, typically a backing containing a film, nonwoven, or fabric containing the pressure-sensitive adhesive is secured to a surface of the device. In many instances the devices are polymeric, and therefore it can be difficult to obtain bonding between the polymeric material of the device and the polymeric layers that contain the pressure-sensitive adhesive. Additional adhesives and adhesive tapes can be used to secure the pressure-sensitive adhesive film to a device. Alternatively, thermal bonding is commonly used to fuse plastic parts.

### SUMMARY

The disclosed thermally bondable adhesive tape backing has a pressure-sensitive adhesive surface and a thermally bondable surface for thermal bonding to a device. The disclosed thermally bondable adhesive tape backing comprises a thermally bondable surface that will secure well to a device while also maintaining the adhesive strength of the underlying pressure-sensitive adhesive.

When heat is transferred through a pressure-sensitive adhesive to create the bond between a thermally bondable surface and a device, the viscosity of the pressure-sensitive adhesive is lowered. If the bonding heat is too high, the pressure-sensitive adhesive can displace at the region of thermal bonding causing the pressure-sensitive adhesive to lose adhesive strength.

The disclosed thermoplastic polyurethane adhesive at the thermally bondable surface softens and melts at a relatively low temperature. Therefore, melting of thermoplastic polyurethane adhesive is achieved while the pressure-sensitive adhesive surface remains in place and is not pressed away at the region of the thermal bonding.

Additionally, the thermoplastic polyurethane adhesive bonds to high surface energy polymeric devices, which are often hard, durable and commonly used for external surfaces of medical or wearable devices. When these medical or wearable devices are strongly bonded to the thermally bondable adhesive tape backing, a strong and secure connection is made at the interface with the thermoplastic polyurethane adhesive, while a pressure-sensitive adhesive can be used for contacting with a surface, like skin.

In one embodiment, an article comprises a device and a thermally bondable adhesive tape backing. The thermally bondable adhesive tape backing comprises a first major surface and a second major surface, opposite the first major surface. The thermally bondable adhesive tape backing has a thermoplastic polyurethane adhesive at the first major surface and a pressure-sensitive adhesive at the second major surface. The device is thermally bonded to the thermoplastic polyurethane adhesive. The pressure-sensitive adhesive remains in an area underlying the device.

In one embodiment, the thermoplastic polyurethane adhesive bonds to a thermoplastic surface of the device. In one embodiment, the thermoplastic surface of the device is polycarbonate, acrylonitrile butadiene styrene, or combinations thereof. In one embodiment, the thermoplastic polyurethane adhesive has a melt temperature less than 140° C. In one embodiment, the thermoplastic polyurethane adhesive has a softening temperature less than 130° C. In one embodiment, the thermoplastic polyurethane adhesive additionally comprises polyether units, polyester units, polycaprolactone units, or combinations thereof. In one embodiment, the thermoplastic polyurethane adhesive continuously extends at the first major surface. In one embodiment, the thermoplastic polyurethane adhesive is in a pattern at the first major surface. In one embodiment, the thermoplastic polyurethane adhesive is a film at the first major surface. In one embodiment, the thermoplastic polyurethane adhesive comprises particles, fibers, fabric, a woven material, or a nonwoven material.

In one embodiment, the thermally bondable adhesive tape backing further comprises a support material adjacent to the pressure-sensitive adhesive and adjacent to the thermoplastic polyurethane adhesive. In one embodiment, the support material is adjacent to the pressure-sensitive adhesive and dispersed through the thermoplastic polyurethane adhesive. In one embodiment, the support material is a film, fabric, woven, knitted, or a nonwoven.

In one embodiment, the pressure-sensitive adhesive continuously extends at the second major surface. In one embodiment, the pressure-sensitive adhesive is in a pattern at the first major surface. In one embodiment, the pressure-sensitive adhesive is a film at the first major surface. In one embodiment, the backing further comprises a liner covering the pressure-sensitive adhesive. In one embodiment, the pressure-sensitive adhesive is an acrylate or a silicone adhesive.

In one embodiment, the device is thermally bonded to the thermoplastic polyurethane adhesive with heat of greater than 120° C. and less than 140° C., force applied of about 5 pounds/inch², and time of about 5 seconds.

In one embodiment, the pressure-sensitive adhesive has a first stick-to-skin peel force and a second stick-to-skin peel force. The first stick-to-skin peel force is determined prior to applying heat and force to the second major surface for a duration of time and the second stick-to-skin peel force is determined after applying heat and force to the second major surface for a duration of time. In one embodiment, the second stick to skin peel force is at least 85% of the first stick to skin peel force. In one embodiment, the second stick to skin peel force is at least 90% of the first stick to skin peel force.

In one embodiment, a process of making an article comprises providing the thermally bondable adhesive tape backing, contacting the device with the thermoplastic polyurethane adhesive of the thermally bondable adhesive tape backing, heating at least a portion of the thermoplastic surface of the device and the thermoplastic polyurethane adhesive, softening the thermoplastic polyurethane adhesive to secure the thermoplastic surface of the device and the thermoplastic polyurethane adhesive. In one embodiment, a heating element contacts the second major surface of the thermally bondable tape backing to heat the thermoplastic polyurethane adhesive. In one embodiment, the second major surface may be covered with a release liner, and the heating element contacts the release liner. In one embodiment, the heating element contacts the second major surface with heat of greater than 120° C. and less than 140° C., force applied of about 5 pounds/inch², and time of about 5 seconds.

In one embodiment, the article is used by applying the second surface of the thermally bondable adhesive tape backing to a substrate, such as skin. In one embodiment, a liner is removed from the second surface of the thermally bondable tape backing prior to application to the substrate.

### BRIEF DESCRIPTION OF DRAWINGS

FIG. 1 is a side sectional view of a device secured to a backing where the pressure and heat from the heat press displaced the pressure-sensitive adhesive under the device;

FIG. 2 is a side sectional view of one embodiment of a thermally bondable adhesive tape backing secured to a device;

FIG. 3 is a side sectional view of another embodiment of a thermally bondable adhesive tape backing secured to a device;

FIG. 4 is a side sectional view of a device and a heat press coming in contact with the thermally bondable adhesive tape backing.

While the above-identified drawings and figures set forth embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of this invention. The figures may not be drawn to scale.

### DETAILED DESCRIPTION

Medical devices, such as glucose monitoring devices or insulin pumps, are applied to human skin for continuous monitoring or delivery of medication. These devices need to be safely secured to the person's skin for days, and sometimes weeks. Wearable devices such as heart rate monitors can also be applied to human skin for tracking personal health or exercise. Following completion of the monitoring, the device is removed from the skin without damaging the underlying skin. Therefore, if a medical or wearable device was to be very securely attached directly to a person's skin for several days or weeks, a strong adhesive would be needed between the device and the skin.

A backing can be used where the device is secured strongly to one side of the backing, while the other side (which is placed in contact with the skin) has an adhesive that can both hold the device for several days or weeks, while also being removable. Typically, a pressure-sensitive adhesive is used. And typically, the area of the surface containing the pressure-sensitive adhesive is larger than the device to distribute the load and provide stability.

To secure the device to a backing, flowable hot melt adhesives can be used or solidified hot melt adhesives can be thermally bonded to the device with application of heat and pressure. Flowable hot melt adhesives can be a slower manufacturing process for connecting the device to the backing and therefore thermal bonding can be a more desirable process.

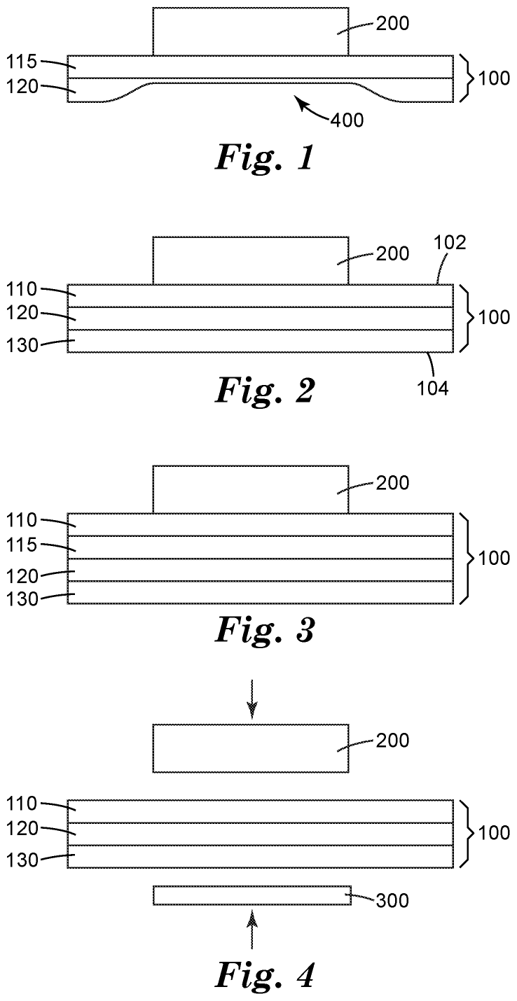

Thermal bonding typically requires heat and pressure to melt and blend together the plastic surfaces contacting one another. In some instances, elevated temperature and pressure is needed to form a bond. These elevated temperature and pressure conditions can damage the materials being bonded together or cause materials to flow. For example, FIG. 1 shows a side-sectional view of an observed problem when high temperature and pressure are used to thermally bond a backing 100 to a device 200. Under the high temperature and pressure, the pressure-sensitive adhesive 120 at a region of thermal bonding 400 underlying the device 200 can be easily pressed away, thereby reducing the adhesive strength of the pressure-sensitive adhesive 120 at the region of thermal bonding 400.

The disclosed thermally bondable adhesive tape backing has a pressure-sensitive adhesive surface and a thermally bondable surface for thermal bonding to a device. The thermoplastic polyurethane adhesive at the thermally bondable surface softens or melts at a low enough temperature to avoid significantly displacing the pressure-sensitive adhesive under the heat and pressure of thermal bonding. Therefore, softening or melting the thermoplastic polyurethane adhesive is achieved while the pressure-sensitive adhesive surface remains in place at the region of the thermal bonding.

Additionally, the thermoplastic polyurethane adhesive is able to bond to high surface energy polymeric devices, which are often hard, durable and commonly used for external surfaces of medical or wearable devices. When these medical or wearable devices are strongly bonded to the thermally bondable adhesive tape backing, a strong and secure connection is made at the interface with the thermoplastic polyurethane adhesive, while a pressure-sensitive adhesive can be used for contacting with a surface, like skin.

FIG. 2 is a side-sectional view of a first embodiment of a thermally bondable adhesive tape backing 100 bonded to a plastic device 200. The backing 100 comprising a first major surface 102 and a second major surface 104 that is opposite the first major surface 102. A thermoplastic polyurethane adhesive 110 is at the first major surface 102. A pressure-sensitive adhesive 120 is at the second major surface 104. Optionally, a release liner 130 can be applied to the pressure-sensitive adhesive 120 to conceal the pressure-sensitive adhesive 120 until use.

As shown in FIG. 2, the thermoplastic polyurethane adhesive 110 achieves bonding with the device 200 following application of heat and pressure through the backing 100, while the pressure-sensitive adhesive 120 remains substantially uniform at the second major surface 104. The pressure-sensitive adhesive 120 had not substantially displaced. Displacement of the pressure-sensitive adhesive 120 lowers the adhesive strength of the pressure-sensitive adhesive 120. Thermoplastic polyurethane adhesive 110 with a relatively low melt or softening temperature will provide for bonding to the device, while less heat and pressure are needed at the pressure-sensitive adhesive 120, which might displace the pressure-sensitive adhesive 120. In one embodiment, the thermoplastic polyurethane adhesive 110 has a melt temperature less than 140° C. or softening temperature less than 130° C. to prevent displacement of the pressure-sensitive adhesive 120 during thermal bonding, such as shown in FIG. 1.

As shown, the thermoplastic polyurethane adhesive 110 covers substantially all of the first major surface 102. It is understood that in some embodiment, the thermoplastic polyurethane adhesive 110 might only cover a portion of the first major surface 102 underlying the plastic device 200.

Similarly, as shown, the pressure-sensitive adhesive 120 covers substantially all of the second major surface 104. It is understood that in some embodiment, the pressure-sensitive adhesive 120 might only cover a portion of the second major surface 104.

FIG. 3 is a side-sectional view of a second embodiment of a thermally bondable multilayer backing 100. In this embodiment, the backing 100 is similar to the embodiment in FIG. 2 but additionally includes support material 115. Support material 115 is between the thermoplastic polyurethane adhesive 110 and the pressure-sensitive adhesive 120. The support material 115 can provide strength and structure to the thin, flexible backing 100. In some embodiments, the support material 115 can partially or entirely penetrate in to the thermoplastic polyurethane adhesive 110 and/or the pressure-sensitive adhesive 120. In some embodiment, the thermoplastic polyurethane adhesive 110 is a separate layer at the surface of the support material 115. In some embodiment, the pressure-sensitive adhesive 120 is a separate layer at the surface of the support material 115.

FIG. 4 is a side-sectional view of a device 200 and a heat press 300 coming in contact with the thermally bondable adhesive tape backing 100. Unlike the process shown in FIG. 1, which can deform and displace the pressure-sensitive adhesive 120, for the backing 100, the underlying pressure-sensitive adhesive 120 does not displace or only minimally displaces under the heat and pressure used to bond the device 200 to the thermoplastic polyurethane adhesive 110.

Without wishing to be bound to a theory, it has been found that the thermoplastic polyurethane adhesives 110 according to the present disclosure advantageously bond to high energy thermoplastics such as polycarbonate or acrylonitrile butadiene styrene, which are typically not weldable to thermoplastic substrates other than themselves. This characteristic is advantageous so that high surface energy thermoplastic devices 200 can be bonded to backings, which can then be applied to the skin. Further, the thermoplastic polyurethane adhesive 110 melts at a temperature low enough to avoid significantly displacing the pressure-sensitive adhesive 120 when heat is applied. This is advantageous in that the thermoplastic polyurethane adhesive 110 can bond with a surface of a thermoplastic device 200 and not displace the pressure-sensitive adhesive 120 when heat and pressure is applied. Therefore, the pressure-sensitive adhesive 120 can bond to the skin of a patient more effectively than when it is displaced as shown in FIG. 1.

The disclosed thermally bondable adhesive tape backing 100 comprises a thermoplastic polyurethane adhesive 110, a pressure-sensitive adhesive 120, and optionally a support material 115, optionally a release liner 130, and optionally additional fillers.

The thermoplastic polyurethane adhesive 110 has a melt temperature low enough to avoid significant flow of the pressure-sensitive adhesive. The pressure-sensitive adhesive 120 remains substantially uniform (i.e., uniform thickness or uniform volume) over the second major surface 104. Specifically, the pressure-sensitive adhesive 120 remains substantially uniform in the area at thermal bonding (i.e., the area underlying the bonded device 200) and the adjacent areas outside of thermal bonding. Pressure-sensitive adhesive 120 can be easily displaced when pressure required to create the thermal bond is applied. Displacement means less pressure-sensitive adhesive 120 is present on the surface after applying heat than prior to applying heat such that adhesion is diminished. Displacement can occur if the temperature to melt the thermoplastic polyurethane adhesive 110 has raised the temperature of the pressure-sensitive adhesive 120 enough to cause the pressure-sensitive adhesive 120 to flow from the surface. In one embodiment, the temperature where displacement begins to occur is approximately 140° C. for commonly used acrylate-based and silicone-based pressure sensitive adhesives. Therefore, in one embodiment, the thermoplastic polyurethane adhesive 110 has a melt temperature less than 140° C. or softening temperature less than 130° C.

The thermoplastic polyurethane adhesive 110 can include polyester units, polyether units, polycaprolactone units, and combinations thereof. It has been found, that thermoplastic polyurethane adhesive 110 with polyester units, polyether units, polycaprolactone units are more compatible with high energy thermoplastic devices. Examples of suitable thermoplastic polyurethane adhesives are Lubrizol™ Pearlbond 1160L, Lubrizol™ Pearlbond 360 EXP, or Lubrizol™ Tecoflex EG-80A available from Lubrizol Advanced Materials, Brecksville, Ohio.

Thermoplastic polyurethanes adhesives 110 are generally prepared by the polymerization of a polyol or long chain diol with a diisocyante and an optional short chain diol extender. Methods of polymerization and additional additives are known to a person of skill in the art. For example, PCT Publication WO2016/144676 discloses thermoplastic polyurethane adhesives 110 that can be used according to the present disclosure and the disclosure of which is incorporated herein by reference. Examples of useful polyisocyanates include aromatic diisocyanates such as 4,4′-methylenebis(phenyl isocyanate) (MDI), 1,6-hexam ethylene diisocyanate (HDI), m-xylene diisocyanate (XDI), phenyl ene-1,4-diisocyanate, naphthalene-1,5-diisocya-nate, and toluene diisocyanate (TDI); as well as aliphatic diisocyanates such as isopho-rone diisocyanate (IPDI), 1,4-cyclohexyl diisocyanate (CHDI), decane-1, 10-diisocya-nate, lysine diisocyanate (LDI), 1,4-butane diisocyanate (BDI), isophorone diisocyanate (PDI), 3,3′-dimethyl-4,4′-biphenylene diisocyanate (TODI), 1,5-naphthalene diisocyanate (NDI), and dicyclohexylmethane-4,4′-diisocyanate (H12MDI). Isomers of these diisocyanates may also be useful. Mixtures of two or more polyisocyanates may be used. In some embodiments, the polyisocyanate is MDI and/or H12MDI. In some embodiments, the polyisocyanate consists essentially of MDI. In some embodiments, the polyisocyanate consists essentially of H12MDI.

Diols comprising polyester intermediates include linear polyesters having a number average molecular weight (Mₙ) of from about 500 to about 10,000, for example, about 3,000 to about 6,000 Daltons, further for example about 4,000 to about 6,000 Daltons. The molecular weight is determined by assay of the terminal functional groups and is related to the number average molecular weight. The polyester intermediates may be produced by (1) an esterification reaction of one or more glycols with one or more dicarboxylic acids or anhydrides or (2) by transesterification reaction, i.e., the reaction of one or more glycols with esters of dicarboxylic acids. Mole ratios generally in excess of more than one mole of glycol to acid are preferred so as to obtain linear chains having a preponderance of terminal hydroxyl groups. The dicarboxylic acids of the desired polyester can be aliphatic, cycloaliphatic, aromatic, or combinations thereof. Suitable dicarboxylic acids which may be used alone or in mixtures generally have a total of from 4 to 15 carbon atoms and include: succinic, glutaric, adipic, pimelic, suberic, azelaic, sebacic, isophthalic, terephthalic, cyclohexane dicarboxylic, and the like. Anhydrides of the above dicarboxylic acids such as phthalic anhydride, tetrahydrophthalic anhydride, or the like, can also be used. The glycols which are reacted to form a desirable polyester intermediate can be aliphatic, aromatic, or combinations thereof, and have a total of from 2 to 20 or from 2 to 12 carbon atoms. Suitable examples include ethylene glycol, 1,2-propanediol, 1,3-propanediol, 1,3-butanediol, 1,4-butanediol, 1,5-pentane-diol, 1,6-hexanediol, 2, 2-dimethyl-1,3-propanediol, 1,4-cyclohexanedimethanol, deca-methylene glycol, dodecamethylene glycol, and mixtures thereof.

Suitable diols comprising polyether intermediates include polyether poly-ols derived from a diol or polyol having a total of from 2 to 15 carbon atoms. In some embodiments, the hydroxyl terminated polyether is an alkyl diol or glycol which is reacted with an ether comprising an alkylene oxide having from 2 to 6 carbon atoms, typically ethylene oxide or propylene oxide or mixtures thereof. For example, hydroxyl functional polyether can be produced by first reacting propylene glycol with propylene oxide followed by subsequent reaction with ethylene oxide. Primary hydroxyl groups resulting from ethylene oxide are more reactive than secondary hydroxyl groups and thus are preferred. Useful commercial polyether polyols include poly(ethylene glycol) comprising ethylene oxide reacted with ethylene glycol, poly(propylene glycol) comprising propylene oxide reacted with propylene glycol, poly(tetram ethylene glycol) comprising water reacted with tetrahydrofuran which can be described as polymerized tetrahydrofuran, and which is commonly referred to as PTMEG.

The thermoplastic polyurethane adhesive 110 may be applied as a film and/or may be imbedded in a support material 115. In an embodiment, the thermoplastic polyurethane covers the entire surface area of the backing 100. In some embodiments, the thermoplastic polyurethane adhesive 110 covers only a portion of the backing 100. In some embodiments, the thermoplastic polyurethane adhesive 110 cover a portion of the backing 110 underlying the device 200. For example, the thermoplastic polyurethane adhesive 110 might be applied in select regions or as a pattern, such as lines, discrete elements. In one embodiment the thermoplastic polyurethane adhesive 110 may be formed in to pellets, particles, strands, or fibers and used on the backing 110. For example, if the thermoplastic polyurethane adhesive 110 is formed into fibers, using conventional fiber forming techniques, those thermoplastic polyurethane adhesive 110 fibers may themselves be formed into a woven, knitted, or nonwoven for use with the backing 100.

The thermoplastic polyurethane adhesive 110 can optionally include other fillers or materials imbedded in the thermoplastic polyurethane adhesive 110. Optional additional fillers and materials can include fibers, silica, webbing materials, woven materials, absorbent particles and fibers, nonwoven materials, and metal particulates. In one embodiment, the thermoplastic polyurethane adhesive melts at a temperature less than 140° C., less than 135° C., less than 130° C.

The pressure-sensitive adhesive 120 can include any adhesive that provides acceptable adhesion to skin and is acceptable for use on skin (e.g., the adhesive should preferably be non-irritating and non-sensitizing). The pressure-sensitive adhesive 120 should remain substantially uniform (i.e., uniform thickness or uniform volume) over the second major surface 104 following thermal bonding. Specifically, the pressure-sensitive adhesive 120 remains substantially uniform between in the area at thermal bonding (i.e., the area underlying the bonded device 200) and the adjacent areas outside of thermal bonding In one embodiment, suitable pressure-sensitive adhesives 120 include adhesives which are displaced at a temperature greater than 140° C. Displacement means less pressure-sensitive adhesive is present on the surface after applying heat than prior to applying heat such that adhesion is diminished. Displacement can occur if the temperature to melt the thermoplastic polyurethane adhesive has raised the temperature of the pressure-sensitive adhesive enough to cause the pressure-sensitive adhesive to flow from the surface.

Displacement of the pressure-sensitive adhesive 120 can cause decreased adhesion of the pressure-sensitive adhesive 120 to the skin. Peel force is one measure of adhesion of a pressure-sensitive adhesive. The stick-to-skin peel force can be measured using methods known in the art. In one embodiment, the stick-to-skin peel force of the pressure-sensitive adhesive 120 after heat is applied to the backing 100 is at least 85%, at least 90%, or at least 95% relative to the stick-to-skin peel force prior to applying heat to the backing 100.

Suitable adhesives are pressure-sensitive and in certain embodiments have a relatively high moisture vapor transmission rate to allow for moisture evaporation. Suitable pressure-sensitive adhesives 120 include those based on acrylates, urethane, hydrogels, hydrocolloids, block copolymers, silicones, rubber-based adhesives (including natural rubber, polyisoprene, polyisobutylene, butyl rubber etc.) as well as combinations of these adhesives. The adhesive component may contain tackifiers, plasticizers, rheology modifiers as well as active components including for example an antimicrobial agent.

The pressure-sensitive adhesives 120 that may be used in the backing 100 may include adhesives that are typically applied to the skin such as the acrylate copolymers described in U.S. Patent No. RE 24,906, particularly a 97:3 isooctyl acrylate:acrylamide copolymer. Another example may include a 70:15:15 isooctyl acrylate: ethyleneoxide acrylate:acrylic acid terpolymer, as described in U.S. Pat. No. 4,737,410 (Example 31). Other potentially useful adhesives are described in U.S. Pat. Nos. 3,389,827; 4,112,213; 4,310,509; 4,323,557; and 5,876,855. Inclusion of medicaments or antimicrobial agents in the adhesive is also contemplated, as described in U.S. Pat. Nos. 4,310,509 and 4,323,557.

Silicone adhesive can also be used. Generally, silicone adhesives can provide suitable adhesion to skin while gently removing from skin. Suitable silicone adhesives are disclosed in PCT Publications WO2010/056541; WO2010/056543; and WO2013/173588, the disclosure of which are herein incorporate by reference.

The pressure-sensitive adhesives 120 may, in some embodiments, transmit moisture vapor at a rate greater to or equal to that of human skin. While such a characteristic can be achieved through the selection of an appropriate adhesive, it is also contemplated that other methods of achieving a high relative rate of moisture vapor transmission may be used, such as pattern coating the pressure-sensitive adhesive 120 on the backing 100, such as described in U.S. Pat. No. 4,595,001. Other potentially suitable pressure-sensitive adhesives 120 may include blown-micro-fiber (BMF) adhesives such as, for example, those described in U.S. Pat. No. 6,994,904. The pressure-sensitive adhesive 120 used in the backing 100 may also include one or more areas in which the adhesive itself includes structures such as, e.g., the microreplicated structures described in U.S. Pat. No. 6,893,655.

Issued U.S. Patent Nos. 3,645,835 and 4,595,001, the disclosures of which are hereby incorporated by reference, describe methods of making adhesive-coated films and methods for testing their permeability. Preferably, the film/adhesive composite should transmit moisture vapor at a rate equal to or greater than human skin. Preferably, the adhesive coated film transmits moisture vapor at a rate of at least 300 g/m²/24 hrs/37° C./100-10% RH, more preferably at least 700 g/m²/24 hrs/37° C./100-10% RH, and most preferably at least 2000 g/m²/24 hrs/37° C./100-10% RH using the inverted cup method as described in U.S. Pat. No. 4,595,001.

Different portions of the backing 100 may include different adhesives for contact with skin, such as disclosed in PCT Publication WO/2014/003957 titled “Medical Dressing with Multiple Adhesives.” For example, a portion may include an acrylate adhesive while another portion may include a silicone adhesive. In one embodiment, to prevent edge separation, adjacent the perimeter is acrylate adhesive, while near the central portion there is silicone adhesive. In one embodiment, to strongly secure with a device or tubing near the central portion there is acrylate adhesive, while near the perimeter in contact with skin is silicone adhesive.

Optionally, such as described in FIG. 3, there can be a support material 115 adjacent to the thermoplastic polyurethane adhesive 110. The support material 115 provides strength to the thin, flexible backing layer. The support material 115 may have more stiffness and less elasticity than the backing layer. The support material 115 may be a coating, such as an adhesive, or may be a self supporting substrate such as another film, woven, knitted, or nonwoven fabric. For example, U.S. Pat. No. 5,088,483 discloses a permanent adhesive as a reinforcement that could be used as the support material 115. The support material can be comprised of more than one material and can additionally be comprised of multiple layers. Additional layers may include liners, adhesives, self-supporting substrates, and fabrics.

One example of nonwoven for the support material 115 is a high strength nonwoven fabric available from Jacob Holm under the trademark Sontara, including Sontara 8010, a hydroengangled polyester fabric. Other suitable nonwoven webs include a hydroentangled polyester fabric available from Veratec, a division of International Paper of Walpole, Mass. Another suitable nonwoven web is the nonwoven elastomeric web described in U.S. Pat. No. 5,230,701, herein incorporated by reference.

An optional release liner 130 can be included that covers all or a portion of the adhesives to prevent contamination of the adhesives. In one embodiment, the package that contains the adhesive dressing may serve as a release liner 130. Suitable release liners can be made of kraft papers, polyethylene, polypropylene, polyester or composites of any of these materials. In one embodiment, the liners are coated with release agents such as fluorochemicals or silicones. For example, U.S. Pat. No. 4,472,480, the disclosure of which is hereby incorporated by reference, describes low surface energy perfluorochemical liners. In one embodiment, the liners are papers, polyolefin films, or polyester films coated with silicone release materials.

The thermally bondable adhesive tape backing 100 can be provided in roll form or sheet form. Then, like shown in FIG. 4, a device 200 can be bonded to the thermally bondable adhesive backing 100. A method of bonding a device 200 to the backing 100 can comprise bringing a surface of the device 200 into contact with thermoplastic polyurethane adhesive 110 at the first major surface 102 of the backing 100, bringing a heating element 300 into contact with the second surface of the backing 100 perpendicular to the device 200, melting or softening the thermoplastic polyurethane adhesive 110 that is in contact with the device 200, and removing the heating element 300, thereby allowing the thermoplastic polyurethane adhesive 110 to cool and bond to the device 200. In another embodiment, the order in which the device 200 and heating element come in contact with the backing 100 may be reversed. The temperature of the heating element may be any temperature which melts the thermoplastic polyurethane adhesive 110 while not damaging the pressure-sensitive adhesive 120 or causing the pressure-sensitive adhesive 120 to melt-flow. In an embodiment, the temperature of the heating element can be less than 140° C. The heating element can be any object that can melt the thermoplastic polyurethane adhesive 110 when applied to the backing 100. The heating element can apply pressure to the second major surface 104 of the backing 100, such as a pressure of at least about 1 pound/inch², 5 pound/inch², 10 pound/inch², 15 pound/inch², or even 20 pound/inch².

Devices 200 which can be bonded to the backing 100 can comprise thermoplastic, metal, fabrics, or other materials which may be desirable to bond to the backing 100. In an embodiment, the device 200 is comprised of polycarbonate, acrylonitrile butadiene styrene, or combinations thereof. The device 200 can be bonded to a portion of the backing 100 such that the peripheral of the backing 100 extends beyond the peripheral of the device 200, like shown in FIGS. 2-4. This may be advantageous in spreading the weight of the device 200 over a larger surface area of the backing 100 when applied to the skin of a user, providing stability and more pressure-sensitive adhesive 120 area to secure to the underlying surface. Additionally, the peripheral of the backing 100 can act as a tab for removing an optional liner 130. In another aspect, the peripheral of the backing 100 can act as a tab for removing the backing 100 from the skin of the user. In an additional embodiment, the backing 100 can extend to the peripheral of the device 200. In another embodiment, the peripheral of the device 200 extends beyond the peripheral of the backing 100. The device 200 can be a wearable medical device.

A method of using the backing 100 can comprise applying the second major surface 104 containing the pressure-sensitive adhesive 120 to the skin of a user. If a liner 130 is present on the second major surface 104 of the backing 100, the liner 130 is removed prior to applying the second major surface 104 of the backing 100 to the skin of a user. The backing 100 can additionally comprise a device 200 on the first surface of the backing 100.

Although specific embodiments have been shown and described herein, it is understood that these embodiments are merely illustrative of the many possible specific arrangements that can be devised in application of the principles of the invention. Numerous and varied other arrangements can be devised in accordance with these principles by those of skill in the art without departing from the spirit and scope of the invention. The scope of the present invention should not be limited to the structures described in this application, but only by the structures described by the language of the claims and the equivalents of those structures.

### EXAMPLES

### Example 1

Several thermoplastic polyurethanes (listed in Table 1) were extruded into 1 mil films onto 1.3 oz per square yard Sontara® 8010 polyester spunlace fabric from Jacob Holm. A tackified acrylic pressure-sensitive adhesive with silicone coated paper release liner tape, available as 3M 4076 Medical Tape was applied to the uncoated side of the Sontara® polyester spunlace nonwoven.

An additional heat seal construction was made by placing a 1 inch wide by 4 inch long strip of 3M CoTran 9728 film onto the ABS plastic strip (described below), by placing a 1 inch wide by 4 in long strip of 3M 4076 Medical Tape over the 3M CoTrans 9728 tape with the Sontara® 8010 polyester spunlace fabric in contact with the 3M CoTran 9728 film.

Strips 1 inch wide by 4 inches long of the constructions described in Example 1, Table 1, were heat sealed with a Young Technology Precision Thermal Press to 1 inch wide by 5 inch long strips of ABS plastic with the thermal press applied to the silicone coated paper release liner of the 3M 4076 Medical Tape. Either the thermoplastic polyurethane film or the 3M CoTran 9728 was in contact with the surface of the ABS plastic strip. The heat seal conditions were 5 PSI, 5 seconds, and the temperature for each sample is listed in Table 1. The entire 1 in by 4 inch strips of the samples were heat sealed to the ABS plastic strip.

The heat seal strength was then tested by measuring the force required to peel the ABS plastic and tape backing layer apart at a 90° angle. The peel test was performed on a Zwick Z005 using a pull speed of 100 mm/min at 73° F., 50% relative humidity. To initiate the peel test, a small tab on one of the short sides of the 1 inch by 4 inch strip was pulled up about 0.5 inch so that the sample could be inserted into the jaws of the Zwick Z005 testing machine. Each individual sample's result was calculated by taking the average of the force over a 50 mm pull range after discarding the force measurements of the initial 25 mm pull range. Results can be seen in Table 1 is the average of at least 3 replicates.

TABLE 1
Heat seal strength of the described tape constructions

| | Melting | | Average | Heat Seal |
|---|---|---|---|---|
| | Temper- | | Peel | Temper- |
| Thermal | ature | | Force | ature |
| Bonding Layer | (° C.) | TPU type | (g/in.) | (° F.) |
| Lubrizol ™ | 70-75 | Polyester | 1994 | 259 |
| Pearlbond 1160L | | | | |
| Lubrizol ™ | 100-110 | Poly- | 2843 | |
| Pearlbond DIPP | | caprolactone | | |
| 119 | | | | |
| Lubrizol ™ | 110-120 | Polyester | 3034 | |
| Pearlbond 302 | | | | |
| EXP | | | | |
| Lubrizol ™ | 125-135 | Polyether | 582 | |
| Pearlbond 360 | | | | |
| EXP | | | | |
| Lubrizol ™ | Not listed | Polyether | 800 | |
| Tecoflex EG-80A | in TDS | | | |
| 3M CoTran 9728 | N/A | EVA film | 49 | |
| 3M CoTran 9728 | N/A | EVA film | 285 | 280 |
| 3M CoTran 9728 | N/A | EVA film | 394 | 300 |

The effect of heat sealing through the pressure-sensitive adhesive of 3M 4076 Medical Tape was measured by testing the pressure-sensitive adhesive via 180° peel from a 3/16″ LDPE test panel from Aeromat plastics item number TP-LDPE-0187-1-28902705632. Heat sealing the samples to ABS plastic makes them too rigid to test the pressure-sensitive adhesive adhesion to an LDPE substrate. Samples that were 1 inch wide by 5 inches long were instead heat sealed with the Sontara® 8010 polyester spunlace fabric pressed against a secondary silicone coated release liner (the same as in 3M 4076 Medical Tape) and applying the heated plate against the silicone coated paper release liner of the 3M 4076 Medical Tape, available from 3M Company. The pressure-sensitive adhesive had therefore been subjected to heat seal conditions, but the sample was not adhered to the rigid ABS plastic strip.

The peel test was performed by first applying a 1 inch wide by 5 inches long of 3M 4076 medical tape subjected to heat seal conditions to LDPE and rolling once in both directions with a 4.5 pound roller. The sample was then pulled from the LDPE at a 180° angle at 12 inchs/min at 73° F./50% relative humidity. Individual sample results were calculated by averaging the force over a 3.5 inch pull range after discarding the initial 0.5 inch of force measurements. The conditions for the heat sealed samples were 5 psi, 5 seconds, and the temperature listed in Table 2, compared to samples which were not subjected to heat seal conditions. The result in the Table 2 is the average of 10 replicates. Each heat sealed sample's average adhesion to LDPE was compared to the control via a 2 sample T-test. A p value greater than 0.05 indicates that there is 95% confidence of no statistical difference in the average values. A p value less than 0.05 indicates 95% confidence that the averages are statistically different

TABLE 2
Peel test of the pressure-sensitive adhesive.

| | Average Peel Force | P-value of 2 sample |
|---|---|---|
| Heat Seal | from LDPE | T-Test Compared |
| Temperature | (ounces/in.) | to Control |
| None - Control | 25.7 | — |
| 259° F. | 25.1 | 0.685 |
| 300° F. | 19.2 | <0.001 |

All of the listed thermoplastic polyurethane resins could achieve an adhesion to ABS of at least 582 g/in with heat seal conditions of 259° F., 5 seconds, and 5 PSI. Heat sealing with these conditions does not affect the adhesion performance of the pressure-sensitive adhesive compared to a sample which was not heat sealed. Ethylene vinyl acetate (EVA) is a commonly used material to join 2 materials via heat seal. The sample with CoTran 9728 (EVA film with 18.5% vinyl acetate) film required heat seal conditions of 300° F., 5 psi, and 5 seconds to achieve a heat seal strength to ABS of only 394 g/in. Heat sealing with these conditions reduced the adhesion performance of the pressure-sensitive adhesive by approximately 25% compared to a control which was not heat sealed.

### Example 2

Lubrizol™ Pearlbond 1160L was extruded into a 1 mil film onto 1.3 oz per square yard Sontara® 8010 polyester spunlace fabric from Jacob Holm. A double coated tape consisting of acrylic adhesive, thermoplastic elastomer film, silicone medical grade adhesive, and a fluoropolymer coated polypropylene release liner (3M 2477P double coated tape, available from 3M Company) with paper liner removed from the acrylic adhesive was applied with the acrylic adhesive adhering to the uncoated side of the Sontara® 8010 polyester spunlace fabric. Heat seal strength to ABS was tested as described in Example 1 using heat seal conditions of 259° F., 5 PSI, and 5 seconds. The effect of the heat seal conditions on the pressure-sensitive adhesive of this construction was tested as described in Example 1. Testing was performed on sample constructions which were either heat sealed to ABS or subjected to heat seal conditions of 259° F., 5 seconds, and 5 PSI against a silicone release liner and samples of the same construction which were not heat sealed. The result in the table is the average of 5 replicates. A 2 sample T-test was performed to compare the heat sealed sample's average pressure-sensitive adhesive adhesion to LDPE to samples which were not heat sealed. A p value greater than 0.05 indicates that there is 95% confidence of no statistical difference in the average values. See the results of testing in Table 3.

TABLE 3
Peel test of the pressure-sensitive adhesive.

| | Average Peel Force | Average Peel Force |
|---|---|---|
| Heat Seal | of Silicone PSA | of Backing from |
| Conditions | from LDPE (g/in.) | ABS (g/in.) |
| None - Control | 297 | N/A |
| 259° F., 5 seconds, | 285 | 482 |
| and 5 PSI | | |
| P value | 0.682 | N/A |

1. An article comprising:
a device; and
a thermally bondable adhesive tape backing comprising:
a first major surface and a second major surface, opposite the first major surface;
a thermoplastic polyurethane adhesive at the first major surface; and
a pressure-sensitive adhesive at the second major surface;
wherein the device is thermally bonded to the thermoplastic polyurethane adhesive;
wherein the pressure-sensitive adhesive remains in an area underlying the device.

2. The article of claim 1, wherein the thermoplastic polyurethane adhesive bonds to a thermoplastic surface of the device.

3. The article of claim 2, wherein the thermoplastic surface is polycarbonate, acrylonitrile butadiene styrene, or combinations thereof.

4. The article of claim 1, wherein the thermoplastic polyurethane adhesive has a melt temperature less than 140° C.

5. The article of claim 1, wherein the thermoplastic polyurethane adhesive has a softening temperature less than 130° C.

6. The article of claim 1, wherein the thermoplastic polyurethane adhesive additionally comprises polyether units, polyester units, polycaprolactone units, or combinations thereof.

7. The article of claim 1, wherein the thermoplastic polyurethane adhesive continuously extends at the first major surface.

8. The article of claim 1, wherein the thermoplastic polyurethane adhesive is discontinuous at the first major surface.

9. The article of claim 1, wherein the thermoplastic polyurethane adhesive is a film at the first major surface.

10. The article of claim 1, wherein the thermoplastic polyurethane adhesive comprises particles, fibers, fabric, a woven, or a nonwoven.

11. The article of claim 1, further comprising a support material adjacent to the pressure-sensitive adhesive and adjacent to the thermoplastic polyurethane adhesive.

12. The article of claim 1, further comprising a support material adjacent to the pressure-sensitive adhesive and dispersed through the thermoplastic polyurethane adhesive.

13. The article of claim 1, wherein the support material is a film, fabric, woven, or a nonwoven.

14. The article of claim 1, wherein the pressure-sensitive continuously extends at the second major surface.

15. The article of claim 1, wherein the pressure-sensitive adhesive is in a pattern at the first major surface.

16. The article of claim 1, wherein the pressure-sensitive adhesive is a film at the first major surface.

17. The article of any one of the preceding claim 1, further comprising a liner covering the pressure-sensitive adhesive.

18. The article of claim 1, wherein the pressure-sensitive adhesive is an acrylate or a silicone adhesive.

19. The article of claim 1, wherein the device is thermally bonded to the thermoplastic polyurethane adhesive with heat of greater than 120° C. and less than 140° C., force applied of about 5 pounds/inch², and time of about 5 seconds.

20. The article of claim 1, wherein the pressure-sensitive adhesive has a first stick-to-skin peel force and a second stick-to-skin peel force;
wherein the first stick-to-skin peel force is determined prior to applying heat and force to the second major surface for a duration of time and the second stick-to-skin peel force is determined after applying heat and force to the second major surface for a duration of time; and
wherein the second stick-to-skin peel force is at least 85% of the first stick-to-skin peel force.

21. The article of claim 20, wherein the second stick-to-skin peel force is at least 90% of the first stick-to-skin peel force.

22. A method of using the article of claim 1 comprising:
applying the second surface of the thermally bondable adhesive tape backing to the skin of a patient.

23. The method of claim 22, wherein the method further comprises removing a liner from the second surface of the thermally bondable adhesive tape backing.

24. A thermally bondable adhesive tape backing comprising:
a first major surface and a second major surface, opposite the first major surface;
a thermoplastic polyurethane adhesive at the first major surface, wherein the thermoplastic polyurethane adhesive has a melt temperature less than 140° C.; and
a pressure-sensitive adhesive at the second major surface.

25. The thermally bondable adhesive tape backing of claim 24, wherein thermoplastic polyurethane adhesive has a softening temperature less than 130° C.

26. The thermally bondable adhesive tape backing of claim 24, further comprising a support material adjacent to the pressure-sensitive adhesive and adjacent to the thermoplastic polyurethane adhesive.

27. The thermally bondable adhesive tape backing of claim 24, wherein the pressure-sensitive adhesive is an acrylate or a silicone adhesive.

28. The thermally bondable adhesive tape backing of claim 24, wherein the thermoplastic polyurethane adhesive comprises particles, fibers, fabric, a woven, or a nonwoven.

29. The thermally bondable adhesive tape backing of claim 24, further comprising a support material adjacent to the pressure-sensitive adhesive and adjacent to the thermoplastic polyurethane adhesive.

30. The thermally bondable adhesive tape backing of claim 29, wherein the support material is a film, fabric, woven, or a nonwoven.

31. A process for securing a device to the thermally bondable adhesive tape backing of claim 1 comprising:
contacting the device with the thermoplastic polyurethane adhesive of the thermally bondable backing;
heating at least a portion of the thermoplastic surface of the device and the thermoplastic polyurethane adhesive;
softening the thermoplastic polyurethane adhesive to secure the thermoplastic surface of the device and the thermoplastic polyurethane adhesive.

32. The process of claim 31, wherein a heating element contacts the second major surface of the thermally bondable adhesive tape backing to heat the thermoplastic polyurethane adhesive.

33. The process of claim 32, wherein the heating element contacts the second major surface with heat of greater than 120° C. and less than 140° C., force applied of about 5 pounds/inch², and time of about 5 seconds.
